(19) United States
(12) Patent Application Publication
(10) Pub. No.: US 2008/0034139 A1
(43) Pub. Date: Feb. 7, 2008

(54) MEMORY ACCESS CONTROLLER AND METHOD THEREOF

(75) Inventors: Qi Han, Suzhou (CN); Yan Xiao, Suzhou (CN)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 11/829,956

(22) Filed: Jul. 30, 2007

(30) Foreign Application Priority Data
Aug. 1, 2006 (CN) 200610109103.7

(51) Int. Cl. G06F 13/16

(52) U.S. Cl. 710/110; 711/167

(57) ABSTRACT

A memory access controller that improves SDRAM access performance with the enhanced AHB bus protocol includes at least one memory access master for issuing a memory access instruction including an HLEN signal that represents the burst length of the transmitting data; and a memory access controller for controlling the access to the memory on the basis of the HLEN signal generated by the memory access master.

### BACKGROUND OF THE INVENTION

The present invention generally relates to enhanced AHB bus protocol to improve memory access's performance. In particular, the present invention relates to a memory access control apparatus, memory access control method that can improve the SDRAM access performance with the enhanced AHB bus protocol, computer program and storage medium thereof.

As the demand for more powerful and flexible computing devices increases, more and more System-on-Chip (SoC) are being developed. Many SoCs comprise Application Specific Integrated Circuits (ASICs) that are offered by several companies.

The Advanced RISC Machines (ARM) microprocessor is very popular for SoC solutions. Today it is fair to say that the ARM Embedded Technology is universally recognized as an industry standard for ASIC design for portable applications. Creating and applying powerful, portable and at the same time re-usable intellectual Property (IP), capable of enhancing an ARM core is therefore of utmost importance to any ASIC design center.

The Advanced Microcontroller Bus Architecture (AMBA) is an open standard, on-chip bus specification that details a strategy for the interconnection and management of functional blocks that makes up a SoC. AMBA defines a signal protocol for the connection of multiple blocks in a SoC. It facilitates the development of embedded processors (e.g., ARM microprocessors) with multiple peripherals. AMBA enhances a reusable design methodology by defining a common bus structure for SoC modules.

SoCs, and in particular ARM-based SoCs, are well suited for communication applications, including cable modems, xDSL, Voice-over-IP (VoIP) and Internet appliances, handheld devices (e.g., Personal Digital Assistants), GSM and UMTS systems, digital video cameras, hand sets, and so forth. SoCs can also be used by the automotive industries, e.g. for handling tasks inside a car.

With the popularization of the SoCs in the above mentioned communication and multimedia field, the high bandwidth requirement has become a bottle neck of the SoCs. Advanced High-performance Bus (AHB) is high performance system bus that used widely in industry, and SDRAM is the main memory for most of SoCs system. Thus, it is valuable to improve the memory access speed for the SoCs.

The AMBA AHB is for high-performance, high clock frequency system modules. The AHB acts as the high-performance system backbone bus. AHB supports the efficient connection of processors, on-chip memories and off-chip external memory interfaces with low-power peripheral macrocell functions. AHB is also specified to ensure ease of use in an efficient design flow using synthesis and automated test techniques.

AHB supports multiple bus masters and provides high-bandwidth operation, and AMBA AHB implements the features required for high-performance, high clock frequency systems including burst transfers, split transactions, single-cycle bus master handover, single-clock edge operation, non-tristate implementation, and wider data bus configurations (64/128 bits).

An AMBA AHB design may include one or more bus masters, typically a system would contain at least the processor and test interface. However, it would also be common for a Direct Memory Access (DMA) or Digital Signal Processor (DSP) to be included as bus masters.

The external memory interface, the Advanced Peripheral Bus (APB) bridge and any internal memory are the most common AHB slaves. Any other peripheral in the system could also be included as an AHB slave. However, low-bandwidth peripherals typically reside on the APB.

A typical AMBA AHB system design includes the following components:

AHB master—A bus master is able to initiate read and write operations by providing an address and control information. Only one bus master is allowed to actively use the bus at any one time.

AHB slave—A bus slave responds to a read or write operation within a given address-space range. The bus slave signals back to the active master the success, failure or waiting of the data transfer.

AHB arbiter—The bus arbiter ensures that only one bus master at a time is allowed to initiate data transfers. Even though the arbitration protocol is fixed, any arbitration algorithm, such as highest priority or fair access can be implemented depending on the application requirements. An AHB would include only one arbiter, although this would be trivial in single bus master systems.

AHB decoder—The AHB decoder is used to decode the address of each transfer and provide a select signal for the slave that is involved in the transfer. A single centralized decoder is required in all AHB implementations.

The AMBA AHB bus protocol is designed to be used with a central multiplexer interconnection scheme. Using this scheme all bus masters drive out the address and control signals indicating the transfer they wish to perform and the arbiter determines which master has its address and control signals routed to all of the slaves. A central decoder is also required to control the read data and response signal multiplexer, which selects the appropriate signals from the slave that is involved in the transfer. FIG. 1 illustrates the structure required to implement an AMBA AHB design with three masters and four slaves.

Before an AMBA AHB transfer can commence the bus master must be granted access to the bus. This process is started by the master asserting a request signal to the arbiter. Then the arbiter indicates when the master will be granted use of the bus.

A granted bus master starts an AMBA AHB transfer by driving the address and control signals. These signals provide information on the address, direction and width of the transfer, as well as an indication if the transfer forms part of a burst. Two different forms of burst transfers are allowed: incrementing bursts, which do not wrap at address boundaries; and wrapping bursts, which wrap at particular address boundaries.

A write data bus is used to move data from the master to a slave, while a read data bus is used to move data from a slave to the master.

Every transfer consists of an address and control cycle and one or more cycles for the data. The address cannot be extended and therefore all slaves must sample the address during this time. The data, however, can be extended using the HREADY signal. When LOW this signal causes wait states to be inserted into the transfer and allows extra time for the slave to provide or sample data.

During a transfer the slave shows the status using the response signals, HRESP[1:0]:

OKAY: The OKAY response is used to indicate that the transfer is progressing normally and when HREADY goes HIGH this shows the transfer has completed successfully.

ERROR: The ERROR response indicates that a transfer error has occurred and the transfer has been unsuccessful.

RETRY and SPLIT: Both the RETRY and SPLIT transfer responses indicate that the transfer cannot complete immediately, but the bus master should continue to attempt the transfer.

In normal operation a master is allowed to complete all the transfers in a particular burst before the arbiter grants another master access to the bus. However, in order to avoid excessive arbitration latencies it is possible for the arbiter to break up a burst and in such cases the master must re-arbitrate for the bus in order to complete the remaining transfers in the burst.

An AHB transfer has two distinct sections: the address phase, which lasts only a single cycle; and the data phase, which may require several cycles. This is achieved using the HREADY signal. FIG. 2 shows the simplest transfer, one with no wait states.

In a simple transfer with no wait states, the master drives the address and control signals onto the bus after the rising edge of HCLK and the slave then samples the address and control information on the next rising edge of the clock. After the slave has sampled the address and control it can start to drive the appropriate response and this is sampled by the bus master on the third rising edge of the clock.

This simple example demonstrates how the address and data phases of the transfer occur during different clock periods. In fact, the address phase of any transfer occurs during the data phase of the previous transfer. This overlapping of address and data is fundamental to the pipelined nature of the bus and allows for high performance operation, while still providing adequate time for a slave to provide the response to a transfer.

Every transfer can be classified into one of four different types, as indicated by the HTRANS[1:0] signals as shown in Table 1.

TABLE 1
Transfer type encoding

| HTRANS[1:0] | Type | Description |
|---|---|---|
| 00 | IDLE | Indicates that no data transfer is |
| | | required. The IDLE transfer type is used |
| | | when a bus master is granted the bus, but |
| | | does not wish to perform a data transfer. |
| | | Slaves must always provide a zero wait |
| | | state OKAY response to IDLE transfers and |
| | | the transfer should be ignored by the |
| | | slave. |
| 01 | BUSY | The BUSY transfer type allows bus masters |
| | | to insert IDLE cycles in the middle of |
| | | bursts of transfers. This transfer type |
| | | indicates that the bus master is |
| | | continuing with a burst of transfers, but |
| | | the next transfer cannot take place |
| | | immediately. When a master uses the BUSY |
| | | transfer type the address and control |
| | | signals must reflect the next transfer in |
| | | the burst. The transfer should be ignored |
| | | by the slave. Slaves must always provide |
| | | a zero wait state OKAY response, in the |
| | | same way that they respond to IDLE |
| | | transfers. |
| 10 | NONSEQ | Indicates the first transfer of a burst |
| | | or a single transfer. The address and |
| | | control signals are unrelated to the |
| | | previous transfer. Single transfers on |
| | | the bus are treated as bursts of one and |
| | | therefore the transfer type is |
| | | NONSEQUENTIAL. |
| 11 | SEQ | The remaining transfers in a burst are |
| | | SEQUENTIAL and the address is related to |
| | | the previous transfer. The control |
| | | information is identical to the previous |
| | | transfer. The address is equal to the |
| | | address of the previous transfer plus the |
| | | size (in bytes). In the case of a |
| | | wrapping burst the address of the |
| | | transfer wraps at the address boundary |
| | | equal to the size (in bytes) multiplied |
| | | by the number of beats in the transfer |
| | | (either 4, 8 or 16). |

Furthermore, the AHB supports BURST transfer. Four, eight and sixteen-beat bursts are defined in the AMBA AHB protocol, as well as undefined-length bursts and single transfers. Both incrementing and wrapping bursts are supported in the protocol. Incrementing bursts access sequential locations and the address of each transfer in the burst is just an increment of the previous address. For wrapping bursts, if the start address of the transfer is not aligned to the total number of bytes in the burst (size×beats) then the address of the transfers in the burst will wrap when the boundary is reached. For example, a four-beat wrapping burst of word (4-byte) accesses will wrap at 16-byte boundaries. Therefore, if the start address of the transfer is 0x34, then it has four transfers to addresses 0x34, 0x38, 0x3C and 0x30.

Burst information is provided using HBURST[2:0] and the eight possible types are defined in Table 2.

TABLE 2
Burst signal encoding

| HBURST[2:0] | Type | Description |
|---|---|---|
| 000 | SINGLE | Single transfer |
| 001 | INCR | Incrementing burst of |
| | | unspecified length |
| 010 | WRAP4 | 4-beat wrapping burst |
| 011 | INCR4 | 4-beat incrementing burst |
| 100 | WRAP8 | 8-beat wrapping burst |
| 101 | INCR8 | 8-beat incrementing burst |
| 110 | WRAP16 | 16-beat wrapping burst |
| 111 | INCR16 | 16-beat incrementing burst |

The burst size indicates the number of beats in the burst, not the number of bytes transferred. The total amount of data transferred in a burst is calculated by multiplying the number of beats by the amount of data in each beat, as indicated by HSIZE[2:0].

There are certain circumstances when a burst will not be allowed to complete and therefore it is important that any slave design which makes use of the burst information can take the correct course of action if the burst is terminated early.

As an example, FIG. 3 shows a four-beat wrapping burst with a wait state added for the first transfer. As the burst is a four-beat burst of word transfers the address will wrap at 16-byte boundaries, hence the transfer to address 0x3C is followed by a transfer to address 0x30. The only difference with the incrementing burst is that the addresses continue past the 16-byte boundary.

It can be seen from FIG. 3 that the slave can determine when a burst has terminated early by monitoring the HTRANS signals and ensuring that after the start of the burst every transfer is labeled as SEQUENTIAL or BUSY. If a NONSEQUENTIAL or IDLE transfer occurs then this indicates that a new burst has started and therefore the previous one must have been terminated.

If a bus master cannot complete a burst because it loses ownership of the bus then it must rebuild the burst appropriately when it next gains access to the bus. For example, if a master has only completed one beat of a four-beat burst then it must use an undefined-length burst to perform the remaining three transfers.

As for the SDRAM, its timing sequence is relatively complicate compared to the AHB transfer. With respect to the adjacent commands, if their access types or access addresses are different, their timing sequences also are different. There is inherent latency between two commands or between the command and the data in the SDRAM.

FIG. 4 is the timing sequence for the simplest consecutive read bursts that the CAS is 2. Two clock cycles are needed from the command to the data in the ideal case. As for other cases, it needs longer waiting time. It also can be seen from FIG. 4 that the SDRAM only has a certain waiting time between the command and the data, and the SDRAM only trigger once for the same BURST operation command. Furthermore, the SDRAM supports pipeline operation, that is, the next command can be issued before completing the current data transfer. Since the access speed is the fastest for the same page of the SDRAM, the most effective transfer manner is the BURST transfer.

However, the SDRAM has inherent latency between two commands or between the command and the data, thus there are two disadvantages for AHB masters to access the SDRAM.

One is AHB does not support address phase and data phase split transfer, it means that if only one AHB master access the SDRAM and then the SDRAM access latency can not be hidden, because the next command can not be sent before current command has be finished. The way to deal with it is the on-chip memory controller supports multiple AHB masters to access the external SDRAM and the memory controller can calculate and send commands to the SDRAM before other commands have been finished to hide latency.

Another fault of AHB protocol is that the burst length it supports is fixed at 4, 8, 16 or unfixed length using increment type, while most multimedia application transfer's burst length is not 4, 8 or 16. The fault will waste access cycle and decrease the system performance.

Based on the original AHB protocol, the AHB master will define the burst length bigger than actual value or using increment burst type for the burst length which is not 4, 8 or 16, and then interrupts the transfer by sending transfer type nonsequence and idle on the address phase. The interrupt can be available only during the last AHB address phase of the burst, which causes several cycles to be wasted no matter what the burst operation is. For fixed burst length, the next command has been sent before the interrupt. For increment transfer, the next command can not to be sent till the current transfer has been finished.

For the burst length which is not 4, 8 or 16, the next command also can not to be sent till the current transfer has been finished. Since the SDRAM only can obtain the related information on the last-AHB address phase and the SDRAM generally needs 4 to 8 clock cycles, the memory controller also can not mask the waiting time. Thus, it will cause the access cycles being wasted and the system performance being decreased.

Accordingly, an object of the present invention is to provide a memory access controller and a memory access control method that overcomes the above mentioned short comings in the prior art.

### BRIEF DESCRIPTION OF THE DRAWINGS

The accompanying drawings, which are incorporated in and constitute a part of the specification, illustrate embodiments of the invention and, together with the description, serve to explain the principles of the invention. In the drawings:

FIG. 1 illustrates the structure required to implement an AMBA AHB design with three masters and four slaves;

FIG. 2 shows the simplest transfer for an AHB transfer, one with no wait states;

FIG. 3 shows, as an example, a four-beat wrapping burst with a wait state added for the first transfer during the AHB transfer;

FIG. 4 is the timing sequence for the simplest consecutive read bursts that the CAS is 2 with respect to the SDRAM;

FIG. 5 shows the read operation according to the enhanced AHB bus of the present invention;

FIG. 6 is a block diagram of the memory controller with plural AHB masters according to the enhanced AHB bus of the present invention;

FIG. 7 shows the structure of the decoder in the memory controller according to the enhanced AHB bus of the present invention;

FIG. 8 is a flow chart of the memory access process according to the enhanced AHB of the present invention; and

FIG. 9 is an SDRAM on page read timing diagram with CAS=2 according to the enhanced AHB and the prior art respectively.

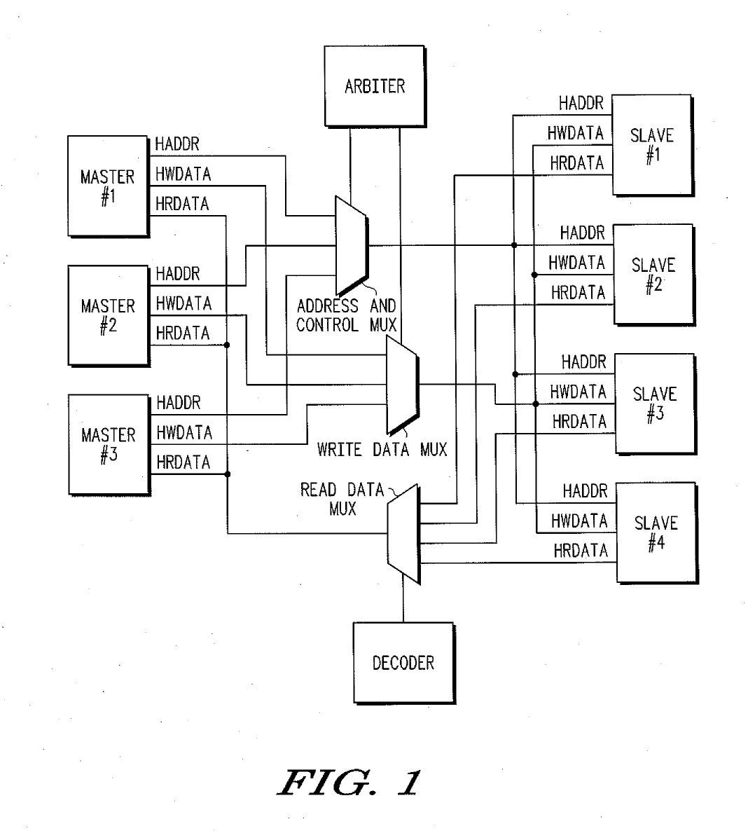

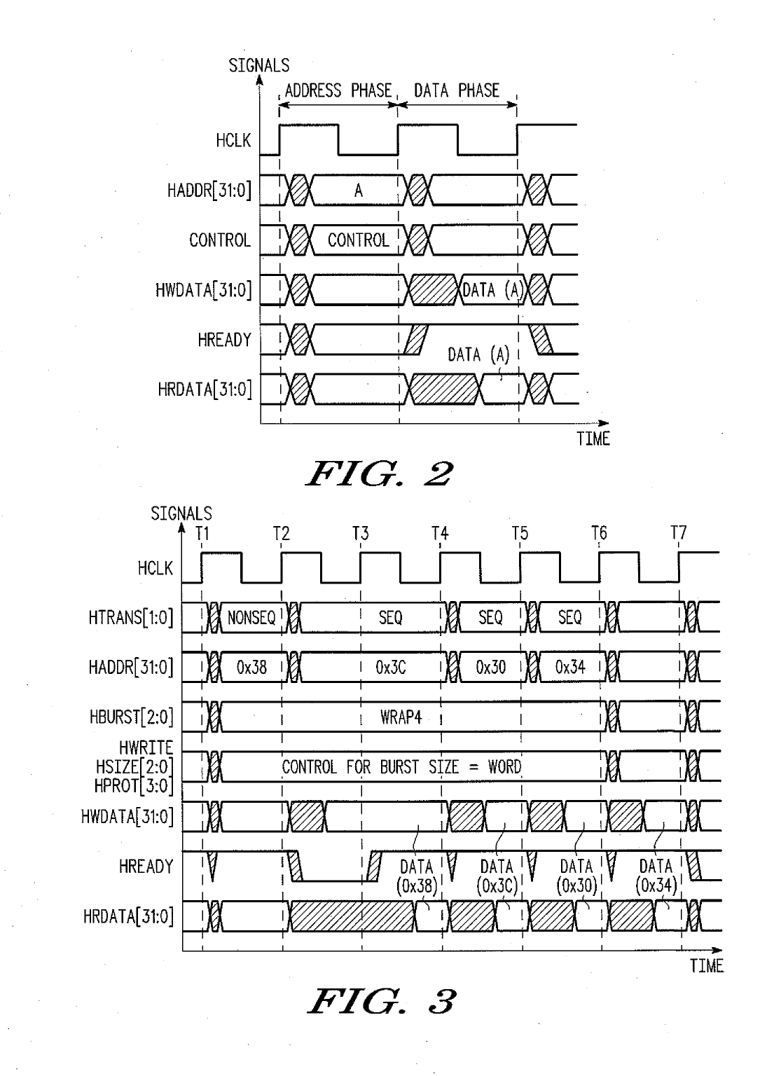

### DETAILED DESCRIPTION OF THE INVENTION

In the following detailed description, numerous specific details are set forth in order to provide a thorough understanding of the invention. However, it will be appreciated by one of ordinary skill in the art that the present invention shall not be limited to these specific details.

To achieve the aforementioned objects, according to an aspect of the present invention, there is provided a memory access control apparatus including at least one memory access master for issuing a memory access instruction including a HLEN signal that represents the burst length of the transmitting data; and a memory access controller for controlling the access to the memory on the basis of the HLEN signal generated by the memory access master.

According to another aspect of the present invention, there is provided a memory access controller having at least one memory access slave for receiving a memory access instruction issued by corresponding memory access master, generating a memory access request and feeding the information of the memory access controller back to the corresponding memory access master, the memory access instruction issued by the corresponding memory access master includes a HLEN signal that represents the burst length of the transmitting data; at least one HLEN signal decoder for decoding the HLEN signal included in the memory access instruction issued by the corresponding memory access master; an arbiter for receiving the memory access request generated by the memory access slave and sorting the received memory access requests to generate sequential access commands; a command buffer for sequentially storing the access commands generated by the arbiter; and a command controller for reading the access command stored in the command buffer and generating a memory access instruction to control the transmission of the data.

According to a further aspect of the present invention there is provided a memory access control method comprising the steps of issuing at least one memory access instruction including a HLEN signal that represents the burst length of the transmitting data; and controlling the access to the memory on the basis of the HLEN signal.

According to another aspect of the present invention, there is provided a memory access control method comprising receiving a memory access instruction, the memory access instruction includes a HLEN signal that represents the burst length of the transmitting data; generating a memory access request on the basis of the memory access instruction; decoding the HLEN signal; receiving the memory access request and sorting the received memory access requests to generate sequential access commands; sequentially storing the access commands; and reading the access command and generating a memory access instruction to control the transmission of the data.

Computer programs for implementing the above memory access control methods are also provided. In addition, computer program products stored on at least one computer-readable medium comprising the program codes for implementing the above said memory access control methods are also provided.

Other objects, features and advantages of the present invention will be apparent from the following description when taken in conjunction with the accompanying drawings, in which like reference characters designate the same or similar parts throughout the drawings thereof.

The enhanced AHB according to the present invention adds one signal HLEN[3:0] from AHB masters to slave, to indicate the actual burst length of the transfer from 1 to 16. The enhanced AHB according to the present invention resolves the cycle waste issues and improves the performance simply for those transfers being not 1, 4, 8 or 16 transfer, and it is back compatible the AHB protocol and needs only very small change.

The enhanced AHB according to the present invention is briefly summarized as following.

1) To give another signals HLEN[3:0], which represent burst length from 1 to 16 respectively. The burst length=HLEN+1. The HLEN keeps the same cycle as HBURST. It will assert in AHB address phase by AHB master and sampled by AHB slave when HTRANS-NONSEQ in the first data phase.

2) For fixed burst length transfer, the HLEN should be equal with the original HBURST length if the burst length transfer is unknown for the AHB master in some cases.

3) For increment unfixed burst length transfer, the HLEN will be ignored by AHB slave. It is suggested that increment usage should be avoided except the burst length is larger than 16.

4) It is option for memory controller to add HLEN_EN, which choose whether the HLEN or HBURST will be used as burst length to back compatible AHB.

5) The HBURST will be kept to back compatible AHB, and gives information about wrap, increment and single transfer.

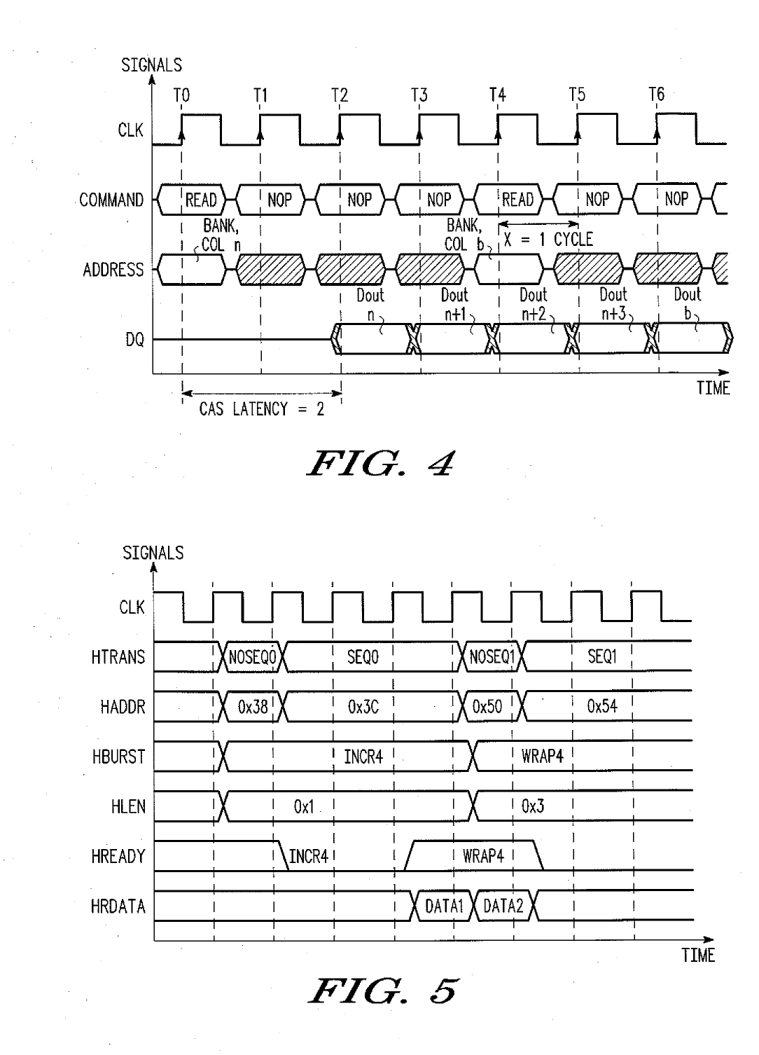

FIG. 5 shows the read operation according to the enhanced AHB bus of the present invention. As shown in FIG. 5, the HLEN signals will be sent out on the first address phase as well as other control signals and retains unchanged during the same burst transfer. The AHB slave will judge whether the HTRANS signal is NONSEQ or not. If yes, the AHB slave samples the HLEN signals. Otherwise, the HLEN signals will be ignored.

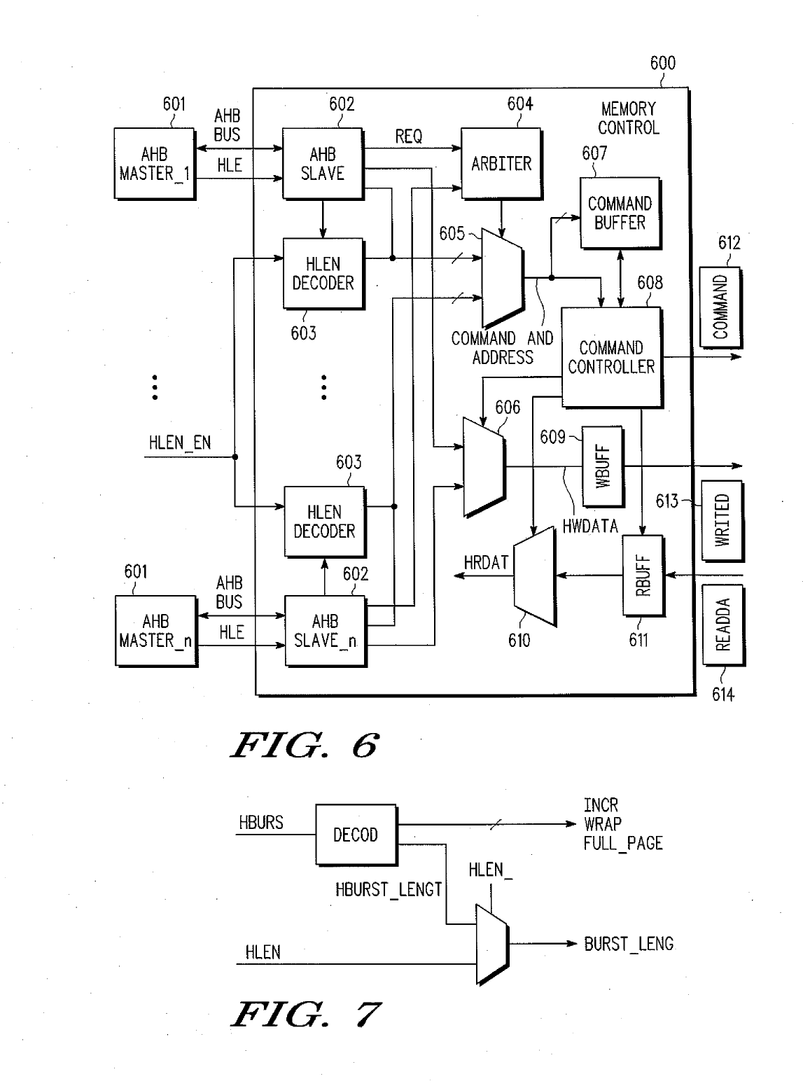

Now the system constitution of realizing high speed SDRAM access by using the enhanced AHB bus according to the present invention will be described in connection with the accompanying drawings. FIG. 6 shows the block diagram of the memory controller with plural AHB masters according to the enhanced AHB bus of the present invention, and FIG. 7 shows the structure of the decoder in the above memory controller according to the enhanced AHB bus of the present invention.

As shown in FIGS. 6 and 7, the memory access system with the enhanced AHB bus according to the present invention mainly includes AHB master portion, AHB interface portion and controller core portion.

The AHB master portion has a plurality of AHB masters 601-1, . . . , 601-n, which send out access requests to the SDRAM memory controller 600.

The AHB interface portion comprises: a plurality of AHB slaves 602-1, . . . , 602-n; arranged corresponding to the plurality of AHB masters 601-1, . . . , 601-n respectively, which receive the access requests from the plurality of AHB masters 601-1, . . . , 601-n, and issue requests to the arbiter 604 when the HTRANS is NONSEQ; a plurality of HLEN decoders 603-1, . . . , 603-n, arranged corresponding to the plurality of AHB masters 601-1, . . . , 601-n respectively, which decode the AHB control signals and the HLEN signals and send the decoded signals as well as other AHB control signals to the arbiter 604 of the memory controller 600. The AHB interface portion also receives the feedback information from the controller core portion, processes the received information and sends back to the AHB master portion.

The controller core portion mainly includes: an arbiter 604 that receives the requests from the respective AHB slaves 602-1, . . . , 602-n, sorts these requests, selects and sends the AHB command to the command buffer 607 through the command & address MUX 605; a command buffer 607 that sequentially stores the plurality of commands from the AHB interface portion; and a command controller 608 that reads the command stored in the command buffer 607, generates corresponding memory access command for accessing the memory and controls the data transfer.

In addition, shows the detailed structure of the HLEN decoder according to the enhanced AHB of the present invention.

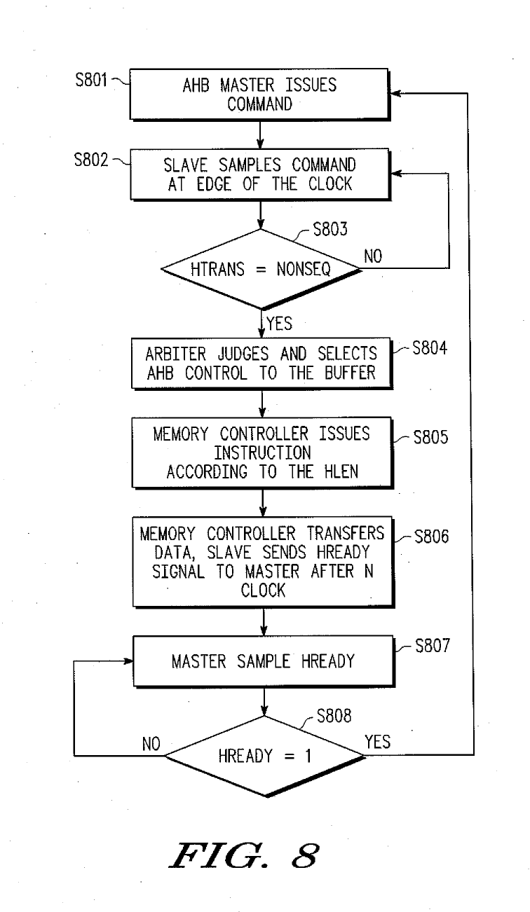

Next, the memory access process will be described in conjunction with the flow chart of FIG. 8. As shown in FIG. 8, in step S801, the AHB master drives the bus address, control signals and HLEN signals at the rising edge of the clock. The respective AHB master can decide whether to issue the HLEN signals or not on the basis of its situation.

Next, in step S802, the AHB slave sample the bus address, control signals and the HLEN signals at the next rising edge of the clock. In step S803, if the HTRANS signal is NONSEQ, the AHB slave issues a request to the arbiter.

Then, in step S803, the HLEN decoder judges whether the HLEN_EN signal is 1. If the HLEN_EN is 1, the AHB slave selects the HLEN as the burst length. Otherwise, the AHB slave selects the decoded HBURST signal as the burst length. The decoder of the HBURST signal, as shown in FIG. 7, also generates the related INCR, WRAP, FULL_PAGE signal described in the above table 2, so as to indicate the type of the burst. All these signals and the other AHB control signals are send to the command & address MUX.

After that, the arbiter in the memory controller in step S804 samples the request signals of the AHB slave, sorts all the transfer requests, selects one of the requests and send the control signals related to the selected request to the command buffer in the memory controller.

Next, in step S805, the command controller 608 in the memory controller 600, on the basis of the current operation status of the memory and the non performed command status (for read or written command, it also includes the information on belonging to which bank and line and the information indicating the HLEN length) in the command buffer, re-sorts the commands by using optimum arithmetic and issues the next command at suitable timing to mask the waiting cycles. If the type of the current operated AHB request is INCR, the issuing of the next command is prohibited and the burst length is ignored, since it is unknown when the current command will be finished. At the same time, the memory controller also monitors the HTRANS signal of the AHB master current performing memory access. If the HTRANS signal is NONSEQ or IDLE, it indicates that the AHB asks for interrupting the current transfer, and then the memory controller issues the next command (if the next command has not been sent out).

Then, in step S806, the memory controller reads data from the memory or writes data to the memory according to the timing sequence of the memory. After the memory controller reads the data, it sends the read data to the AHB. Then, the AHB slave samples and drives the response signal to set HREADY as 1, so as to inform the AHB master that the data transfer has been finished.

Next, in step S807, the AHB master samples the HREADY signal. And in step S808, the AHB master judges whether the HREADY signal is 1. If the HREADY signal is 1, the AHB master issues the next command and the process returns back to step S801.

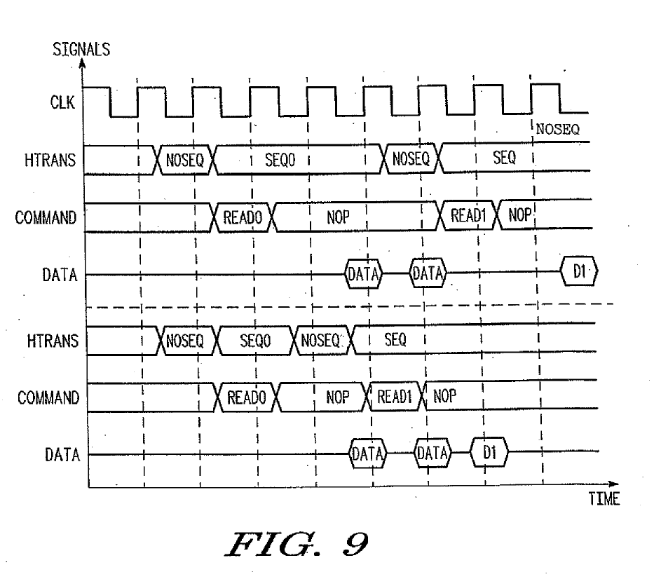

FIG. 9 shows the SDRAM on page read timing diagram with CAS=2 according to the enhanced AHB and the prior art respectively. In FIG. 9, the burst length is 2 and the CAS also is 2. The HTRANS signal belongs to AHB signal, the command belongs to the memory controller signal and the DATA is the read data returned back from the SDRAM to the AHB master. The upper portion above the dotted line is the timing sequence according to the prior AHB and the lower portion under the dotted line is the timing sequence according to the enhanced AHB of the present invention.

In the prior AHB, only when the first data arrives, can the burst transfer completion be known, and thus the data D1 will be received at the third cycles after issuing the command. However, according the enhanced AHB of the present invention, since the end time can be known at the first cycle of the burst, the command of the other masters can be send out in advance, and thus the data D1 can be arrived two cycles earlier than the prior AHB. Accordingly, the SDRAM access performance can be improved.

The enhanced AHB bus according to the present invention has been implemented at RTL level by modifying original AHB memory controller. A typical H.264 pattern QCIF image AVC decoding is running, the QCIF AVC decoding simulation time decreases from 0.076 s to 0.064 s. SDRAM bus utilization increases from 31% to 34%. That means the performance is improved about 10%. Many other multimedia application simulation show good performance improvement also. Based on different application case, it varies from 5% to 15% performance improvement. The simulation is built on only three AHB masters work at the same time, if more masters added, the bus utilization is estimated to be improved from 10˜20% for typical multimedia application.

Because most current designs are based on AHB design, the enhanced AHB protocol is very valuable because it improves the memory system performance dramatically with only very small change, and it is especially important for multimedia application when the memory access becomes the system bottle neck. It also is very convenient for AXI master to be used in an AHB bus system with such enhanced bus performance with very low performance loss compared to AXI protocols.

Further to the above examples, the present invention also may be realized through running a program or a set of programs on any information processing equipment, and may be communicated with any subsequent processing apparatus. The information processing equipment and subsequent processing apparatus all may be well-known equipment.

Therefore, it is important to note that the present invention includes a case wherein the invention is achieved by directly or remotely supplying a program (a program corresponding to the illustrated flow chart in the embodiment) of software that implements the functions of the aforementioned embodiments to a system or apparatus, and reading out and executing the supplied program code by a computer of that system or apparatus. In such case, the form is not limited to a program as long as the program function can be provided.

Accordingly, the program code itself installed in a computer to implement the functional process of the present invention using computer implements the present invention. That is, the present invention includes the computer program itself for implementing the functional process of the present invention.

In this case, the form of program is not particularly limited, and an object code, a program to be executed by an interpreter, script data to be supplied to an OS, and the like may be used as along as they have the program function.

As a recording medium for supplying the program, for example, a floppy disk, hard disk, optical disk, magneto optical disk, MO, CD-ROM, CD-R, CD-RW, magnetic tape, nonvolatile memory card, ROM, DVD (DVD-ROM, DVD-R), and the like may be used.

As another program supply method, connection may be established to a given home page on the Internet using a browser on a client computer, and the computer program itself of the present invention or a file, which is compressed and includes an automatic installation function, may be downloaded from that home page to a recording medium such as a hard disk or the like, thus supplying the program. Also, program codes that form the program of the present invention may be broken up into a plurality of files, and these files may be downloaded from different home pages. That is, the present invention also includes a WNW server that makes a plurality of users download program files for implementing the functional process of the present invention using a computer.

Also, a storage medium such as a CD-ROM or the like, which stores the encrypted program of the present invention, may be delivered to the user, the user who has cleared a predetermined condition may be allowed to download key information that decrypts the program from a home page via the Internet, and the encrypted program may be executed using that key information to be installed on a computer, thus implementing the present invention.

The functions of the aforementioned embodiments may be implemented not only by executing the readout program code by the computer but also by some or all of actual processing operations executed by an OS or the like running on the computer on the basis of an instruction of that program.

Furthermore, the functions of the aforementioned embodiments may be implemented by some or all of actual processes executed by a CPU or the like arranged in a function extension board or a function extension unit, which is inserted in or connected to the computer, after the program read out from the recording medium is written in a memory of the extension board or unit.

What has been describes herein is merely illustrative of the application of the principles of the present invention. For example, the functions described above as implemented as the best mode for operating the present invention are for illustration purposes only. As a particular example, for instance, other design may be used for obtaining and analyzing waveform data to determine speech. Also, the present invention may be used for other purposes besides detecting speech. Accordingly, other arrangements and methods may be implemented by those skilled in the art without departing from the scope and spirit of this invention.

1. A memory access control apparatus connected to a memory via a bus, comprising:
at least one memory access master connected to the bus for issuing a memory access instruction including a HLEN signal that represents the burst length of data to be transmitted on the bus; and
a memory access controller coupled to the at least one memory access master for controlling the access to the memory on the basis of the HLEN signal generated by the memory access master.

2. The memory access control apparatus of claim 1, further comprising a HLEN enable line for applying a HLEN enable signal to the memory access controller.

3. The memory access control apparatus of claim 2, wherein the memory access control apparatus supports an AHB system bus and the memory access master further generates a HBURST signal complying with the AHB system bus.

4. The memory access control apparatus of claim 3, wherein for a fixed burst length transfer, the HLEN is equal with HBURST length if the burst length transfer is unknown.

5. The memory access control apparatus of claim 3, wherein for an increment unfixed burst length transfer, the HBURST signal is used and the HLEN signal is ignored.

6. The memory access control apparatus of claim 1, wherein the memory access controller comprises:
at least one memory access slave for generating a memory access request on the basis of the memory access instruction issued by the corresponding memory access master and feeding the information of the memory access controller back to the corresponding memory access master;
at least one HLEN signal decoder for decoding the HLEN signal included in the memory access instruction issued by the corresponding memory access master;
an arbiter for receiving the memory access request generated by the memory access slave and sorting the received memory access requests to generate sequential access commands;
a command buffer for sequentially storing the access commands generated by the arbiter; and
a command controller for reading the access command stored in the command buffer and generating a memory access instruction to control the transmission of the data.

7. A memory access controller, comprising:
at least one memory access slave for receiving a memory access instruction issued by a corresponding memory access master, generating a memory access request and providing the information of the memory access controller back to the corresponding memory access master, wherein the memory access instruction issued by the corresponding memory access master includes a HLEN signal that represents the burst length of the transmitting data;
at least one HLEN signal decoder for decoding the HLEN signal included in the memory access instruction issued by the corresponding memory access master;
an arbiter for receiving the memory access request generated by the memory access slave and sorting the received memory access requests to generate sequential access commands;
a command buffer for sequentially storing the access commands generated by the arbiter; and
a command controller for reading the access command stored in the command buffer and generating a memory access instruction to control the transmission of the data.

8. The memory access controller of claim 7, further comprising a HLEN enable line for applying a HLEN enable signal to the memory access controller.

9. The memory access controller of claim 8, wherein the memory access controller supports an AHB system bus and the memory access master further generates a HBURST signal complying with the AHB system bus.

10. The memory access controller of claim 9, wherein for fixed burst length transfer, the HLEN is equal with HBURST length if the burst length transfer is unknown.

11. The memory access controller of claim 9, wherein for increment unfixed burst length transfer, the HBURST signal is used and the HLEN signal is ignored.

12. A memory access control method for controlling access to a memory, comprising the steps of:
issuing at least one memory access instruction including a HLEN signal that represents a burst length of data to be transmitted over a bus; and
controlling the access to the memory on the basis of the HLEN signal.

13. The memory access control method of claim 12, further comprising the step of issuing a HLEN enable signal, wherein memory access is dependent on the HLEN signal.

14. The memory access control method of claim 13, wherein the memory access control method supports an AHB system bus and further comprises the step of generating a HBURST signal complying with the AHB system bus.

15. The memory access control method of claim 14, wherein for fixed burst length transfer, the HLEN is equal with HBURST length if the burst length transfer is unknown.

16. The memory access control method of claim 14, wherein for increment unfixed burst length transfer, the HBURST signal is used and the HLEN signal is ignored.

17. The memory access control method of claim 12, wherein the controlling step comprises the steps of:
generating a memory access request on the basis of the memory access instruction;
decoding the HLEN signal included in the memory access instruction;
receiving the memory access request and sorting the received memory access requests to generate sequential access commands;
sequentially storing the access commands; and
reading the access command and generating a memory access instruction to control the transmission of the data.

18. A memory access control method comprising:
receiving a memory access instruction, the memory access instruction includes a HLEN signal that represents a burst length of data being transmitted;
generating a memory access request on the basis of the memory access instruction;
decoding the HLEN signal;
receiving the memory access request and sorting the received memory access requests to generate sequential access commands;
sequentially storing the access commands; and
reading the access command and generating a memory access instruction to control the transmission of the data.

19. The memory access control method of claim 18, further comprising the step of issuing a HLEN enable signal to allow the memory access to be dependent on the HLEN signal.

20. The memory access control method of claim 19, wherein the memory access control method supports an AHB system bus and further comprises the step of generating a HBURST signal complying with the AHB system bus.
